(19) United States
(12) Patent Application Publication
(10) Pub. No.: US 2005/0240528 A1
(43) Pub. Date: Oct. 27, 2005

(54) Smartcard with visual display

(76) Inventor: Colin Hendrick, Brooklyn, NY (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 10/845,864

(22) Filed: May 14, 2004

Related U.S. Application Data
(60) Provisional application No. 60/564,903, filed on Apr. 23, 2004.

(51) Int. Cl. G06F 17/60

(52) U.S. Cl. 705/44

(57) ABSTRACT

A smartcard with visual display is provided that enhances identity verification and outputs information stored on the smartcard. For enhanced identity verification, the visual display outputs identifying features of the individual authorized to use the card. For instance, the visual display outputs a sequence of images of the authorized user's face taken from different perspectives. The visual display also outputs information pertaining to the authorized user, such as medical, financial, or contact information. Also disclosed is a smartcard with visual display having multiple users authorized to use the card. Each of the authorized users may have differing levels of access rights.

### CROSS-REFERENCE TO RELATED APPLICATION

This application claims the benefit of U.S. Provisional Application No. 60/564,903, filed Apr. 23, 2004 by Colin Hendrick and entitled “Smartcard with Visual Display,” the entire disclosure of which is hereby incorporated herein by reference.

### FIELD OF THE INVENTION

This invention relates to a smartcard having a visual display for increased security. In particular, the smartcard according to the present invention includes a visual display for both enhanced identity verification and outputting information stored on the smartcard.

### BACKGROUND OF THE INVENTION

Credit and debit cards are an essential part of business and personal commerce. Card fraud has been a problem from the outset. Early attempts at fraud prevention involved authenticating the card itself. For example, issuing companies and banks printed logos and names on the card. Later, holograms were added to identify legitimate cards. User verification was largely limited to comparing a signature on the card to a signature offered by a user at the time of purchase. This mode of authentication is subjective, often inaccurate, and can be easily evaded. Similar identification cards used to control access to restricted areas suffer similar security weaknesses.

More recently, smartcards have been introduced that incorporate a microcomputer on the face of the card. FIG. 1 shows a typical smartcard 10. Smartcards can retain many of the original credit card security features, including a hologram 17 and a logo 12 which can include a name. The name of the issuing bank or company can also be printed on the face (not shown). If the card is used for conducting transactions, charges can be billed to the card account number 13. Further information may include a card issue date 14 and an expiration date 16. FIG. 2 shows the rear of the card including signature panel 22, a further verification number 23, and a magnetic stripe 21 from which a transaction reader can derive the account number.

The distinguishing feature of the smartcard from conventional cards is a microcomputer 11. Nonvolatile memory on the card can hold basic user information, including verification information that can be read by a suitable smartcard reader. The lines in the metal pattern overlying the microcomputer chip define electrical contacts that provide data connections and power to the microcomputer. Smartcard credit cards have been issued in modest numbers by some institutions. But to date, few merchants make use of the smart features.

The credit or debit card format has also found use in security access control. A typical use is when an individual holding a credit-card-sized security card uses the card to obtain entry into a building. The entry point of the building generally includes a card reader to read a magnetic stripe on the card and grant access based on recognized account numbers or user identification (ID) numbers. In very high security areas a door access system might employ an eye scanner to authorize entry by a particular individual. Here, the sensor and authentication equipment is part of the fixed permanent assembly at the entry point.

It has been suggested that cards might include an on-board fingerprint sensor for user authentication. FIG. 3 shows such a card with fingerprint sensor 31 integral to the card surface. Such a card, while offering improved user authentication, is still relatively limited in usefulness and does not meet the stringent security requirements needed in today's society. Accordingly, there is a need for a device that can verify correct user identity with increased accuracy.

### SUMMARY OF THE INVENTION

This problem is addressed and a technical solution achieved in the art by a smartcard with visual display according to the present invention. The visual display provides enhanced identity verification and outputs information stored on the smartcard. For enhanced identity verification, the visual display reveals identifying features of the individual authorized to use the card (“authorized user”). For instance, the visual display outputs an image of the authorized user's face, a sequence of images of the authorized user's face taken from different perspectives, an image of the authorized user's tattoo, etc. A security guard then looks at this image or sequence of images to verify that the individual showing the card is actually the authorized user.

Further, because the display is a visual display, all sorts of information stored on the smartcard may be viewed. For instance, the authorized user's medical information may be displayed to the authorized user's doctor, financial information may be displayed in the form of a chart, and contact information may be displayed in the form of text. Accordingly, the smartcard with visual display according to the present invention provides enhanced security and unprecedented access to personal data stored on the smartcard.

In more detail, the present invention includes a smartcard for storing information pertaining to an authorized user. The information includes: first identity data, which may be the authorized user's fingerprint; second identity data, which may be an image of the authorized user; and other useful data, which may be medical, financial, or other information. The smartcard includes an energy providing component, a memory component, an access control component, a visual display component, and a processing component. An exemplary energy providing component is a rechargeable, ultra thin, flexible battery. The memory component stores the information pertaining to the authorized user. The access control component receives access data, which may be a fingerprint, from an individual claiming to be the authorized user.

The processing component is connected to the energy providing component, memory component, access control component, and visual display component. The processing component compares the received access data to the first identity data. If the access data does not match the first identity data, the processing component instructs the visual display component to display a warning notification. If the processing component determines that the access data matches the first identity data, the processing component instructs the visual display component to display at least a portion of the information pertaining to the authorized user. For instance, if the access data matches the first identity data, the visual display component: displays the second identity data to allow a security guard to verify that it matches the individual presenting the card. Further, if the access data matches the first identity data, the visual display component displays other useful data stored in the memory component.

Advantageously, the memory component comprises a one-time-programmable (“OTP”) memory and a flash memory. In this situation, the first and second identity data are stored in the OTP memory, and the other useful data is stored in the flash memory. Further, the smartcard advantageously includes one or more interfaces for allowing physical or wireless connection between devices on the smartcard, between the smartcard and external devices, or both.

According to another aspect of the invention, the memory component of the smartcard stores identity and other information for a plurality of authorized users. In this scenario, a single smartcard is used to grant security access to one authorized user at a time. Further, the authorized users may have different levels of access rights.

According to yet another aspect of the invention, a method is provided for testing whether an individual is an authorized user of a smartcard. The method includes receiving access data from the individual via an access control component integral to the smartcard. The method also includes comparing, with a processing component integral to the smartcard, the access data to identity data pertaining to an identity of the authorized user of the smartcard. The identity data is stored in a memory component integral to the smartcard. If the access data does not match the identity data, the method includes displaying a warning notification on a visual display component integral to the smartcard, thereby indicating that the individual is not the authorized user. If the access data matches the identity data, the method includes displaying, with the visual display component, other data stored in the memory component, thereby indicating that the individual is likely the authorized user.

### BRIEF DESCRIPTION OF THE DRAWINGS

A more complete understanding of this invention may be obtained from a consideration of this specification taken in conjunction with the drawings, in which:

FIG. 1 shows a smartcard front face according to the prior art;

FIG. 2 shows a smartcard rear face according to the prior art;

FIG. 3 shows a smartcard front face with a fingerprint sensor;

FIG. 4 shows a first embodiment of the smartcard with visual display according to the present invention;

FIG. 5 shows a second embodiment of the smartcard with visual display according to the present invention; and

FIG. 6 illustrates the process flow according to both exemplary embodiments.

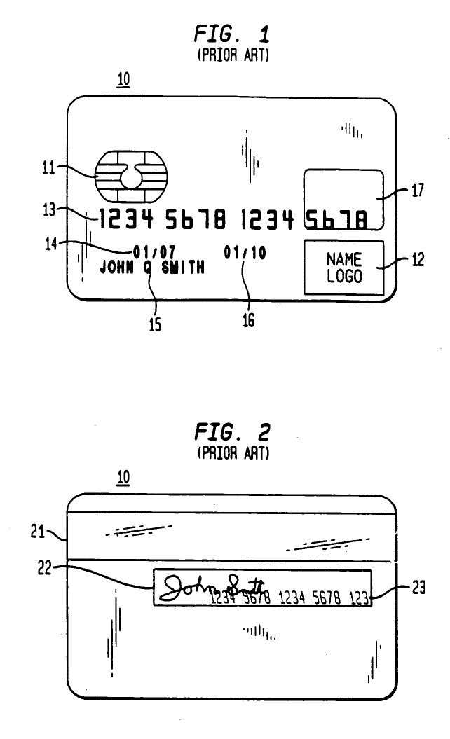

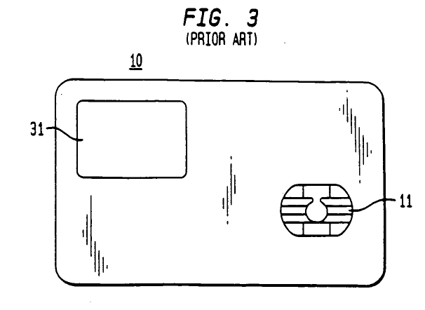

It is to be understood that the drawings are for the purpose of illustrating the concepts of the invention are not to scale.

### DETAILED DESCRIPTION OF THE EXEMPLARY EMBODIMENTS OF THE INVENTION

The smartcard according to the present invention includes a visual display for both enhanced identity verification and outputting personal information stored on the smartcard. As will be described in more detail, the visual display is used to display an image or a sequence of images of the authorized user. In the case where a sequence of images is used, several images of the authorized user taken from different perspectives are displayed to further enhance identity verification. Further, the visual display is used to output important information related to the authorized user. For instance, the visual display reveals critical medical information about the authorized user for medical personnel in the event of an emergency. With included access control devices, such as a fingerprint sensor, the authorized user can restrict access to such personal information.

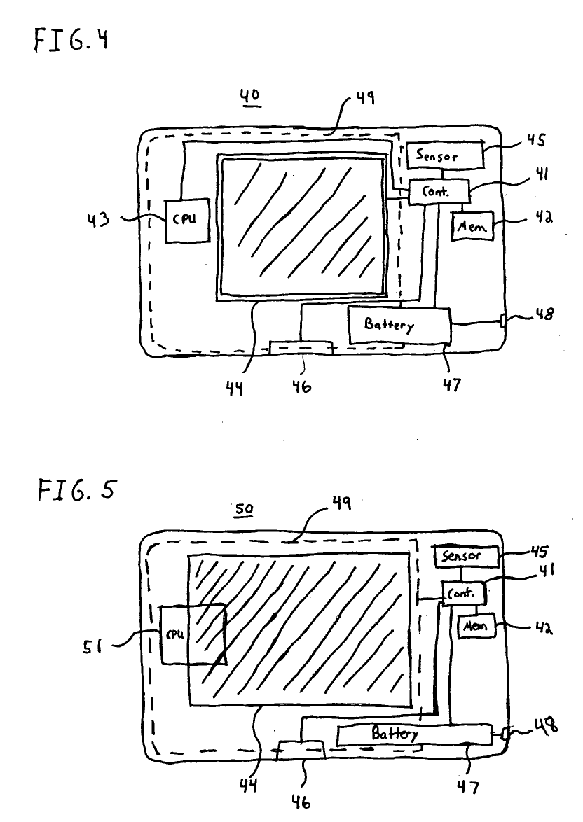

With this framework in mind, the smartcard 40 according to the first embodiment of the present invention will now be described with reference to FIG. 4. The smartcard 40 includes a central IC controller 41 that acts as a data bus and routing device for all of the components built into the smartcard 40. Also included in the smartcard 40 are one or more memory devices (“memory component”) 42 for storing information. As will be discussed, the memory component 42 preferably includes a one-time-programmable (“OTP”) memory and a re- writable nonvolatile memory.

The smartcard 40 also includes a processing component (“CPU”) 43 for processing data and performing identity verification. The processing component 43 includes a read-only memory (“ROM”) that stores the processing component's 43 instructions. The visual display component 44 of the smartcard 40 includes a thin, flexible, liquid crystal display (“LCD”) for displaying stored information. Also included in the smartcard 40 is an access control component (“sensor”) 45. Advantageously, the sensor 45 is a fingerprint sensor for reading an individual's fingerprint that is then compared to the authorized user's fingerprint by the CPU 43. The smartcard 40 also includes an interface port 46 (e.g., a USB port or other ports having physical connections) for transmitting and receiving information from external devices, such as computers. The smartcard 40 optionally includes a wireless interface 49 for communicating wirelessly with external devices. Exemplary wireless interfaces are an RF antenna, an infrared transceiver, or a wireless fidelity (“WiFi”) interfaces.

Further, the smartcard 40 includes an energy providing component 47 and a power connector 48 for receiving energy from external devices. The energy providing component 47 distributes energy to each of the components in the smartcard 40 that require energy, such as the controller 41, the memory component 42, the CPU 43, the display 44, and the sensor 45. An exemplary energy providing component 47 is a rechargeable, ultra thin, flexible battery embedded into the smartcard 40. The energy providing component 47 is recharged as needed by power applied to the power connector 48.

Although not required, one having ordinary skill in the art will appreciate that the smartcard 40 may also include the features and functionality of a credit card or debit card without departing from the scope of the invention. For instance, a magnetic stripe, a hologram, a name, an account number, etc., may easily be incorporated into the smartcard 40. Accordingly, the present invention is not limited to the presence or absence of such features.

Prior to usage of the smartcard 40, the memory component 42 is loaded with reference identity data that will later be used to identify the authorized user. Exemplary reference identity data includes the authorized user's fingerprint data (“reference fingerprint data”) and one or more images of the authorized user (“reference image data”). If multiple images are used, they may include several different images of the authorized user's face, head, or other identifying features of the authorized user. Advantageously, the reference image data includes a sequence of images of the authorized user's face taken from multiple perspectives.

Loading the identity data occurs via the interface port 46 or wireless interface 49. To store the identity data, the memory component 42 advantageously comprises a one-time- programmable (“OTP”) memory. Once written, the identity data in the OTP memory cannot be changed and can only be used to identify the authorized user. Accordingly, once a smartcard 40 is loaded with an authorized user's identity data, it cannot be associated with any other individual. However, an OTP memory need not be used, and a re-writable flash memory may be used to store the identity data instead. Because a re-writable flash memory is not as secure as an OTP memory, strict access rules to the flash memory must be employed. An exemplary solution is to require an authorization code via interface port 46 or wireless interface 49 prior to allowing modification of the identity data.

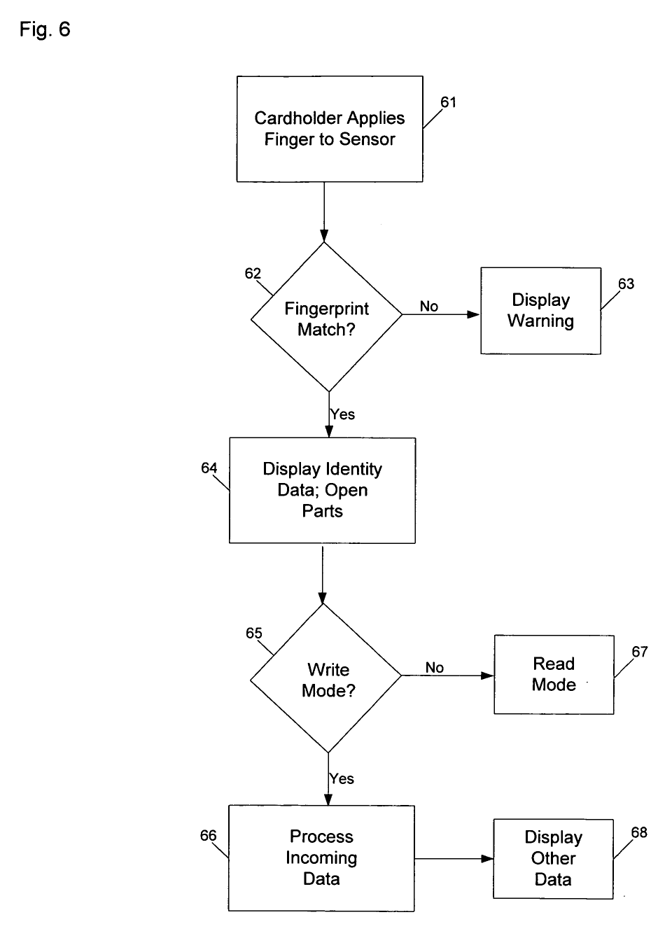

After the identity data has been loaded into the memory component 42, the smartcard 40 is typically issued to the authorized user. With reference to FIG. 6, the smartcard 40 may then used to verify that the individual in possession of the card is in fact the authorized user. At a security access point, a finger of the individual in possession of the smartcard 40 is applied to the fingerprint sensor 45 at 61 in FIG. 6. Most typically, a thumb is used. However, other fingers can be used as well. Fingerprint sensor 45 generates a data pattern representing the individual's fingerprint (“access data”) that is then compared to the reference fingerprint data by the CPU 43 at 62 in FIG. 6. Exemplary devices and algorithms used for reading and comparing fingerprint data are described in U.S. Pat. No. 5,623,552, “Self-authenticating Identification Card with Fingerprint Identification,” to Lane, which is incorporated by reference herein.

If the CPU 43 does not find a match between the access data and the reference fingerprint data at 62, the CPU 43 instructs the visual display component 44 to display a warning message describing the finding at 63. If the CPU 43 finds a match between the access data and the reference fingerprint data at 62, the CPU 43 instructs the visual display component 44 to display the stored images of the authorized user (“reference image data”) at 64. If multiple images are stored, they are displayed in sequence. At this point, the security personnel inspects the images and compares them to the individual carrying the smartcard 40. If the images match the individual holding the smartcard 40, the individual is determined to be the authorized user.

Although commonly described in this specification as being associated with a single authorized user, the smartcard 40 may also be associated with multiple authorized users, such as the members of a team. Each authorized user may be assigned different levels of access rights. This situation is advantageous when it is desired that access be limited to only one person in a group of people at a time. For instance, if access to a computer system is desired to be limited to one person from an organization at a time, a single smartcard 40 may be issued to the entire organization. When one person in the organization needs to use the computer system, that person takes possession of the card and shows it to the security personnel in charge of access to the computer system. When that person places his finger on the fingerprint sensor 45 at 61, the CPU 43 compares the fingerprint to each of the fingerprints of the members of the group stored in memory component 42 at 62. If the CPU 43 finds a match at 62, only the reference images associated with the matching fingerprint are displayed with the display 44 at 64. The security personnel then compares the image to the individual, and if a match is found, grants access to the individual.

This scenario may be extended to situations where it is desired that access be limited to only a couple of people in a group of people at a time. In this scenario, a certain number of smartcards 40, each containing reference identity data for every person in the group, are issued to the group. For instance, if access to a computer system is desired to be limited to five people from an organization at a time, five smartcards 40 may be issued to the entire organization.

Returning back to FIG. 4, the memory component 42 of the smartcard 40 also stores other data about or useful to the authorized user besides the identity data (“other useful data”). If multiple authorized users are loaded into the memory component 42, memory component 42 stores other useful data for each authorized user. For security purposes, each authorized user is allowed to access only the other useful information pertaining to them.

The other useful data may include medical information about an authorized user, such as EKG data, sonograms, digital X-Rays, known allergies, blood type, medical test results, etc. The other useful data may include the authorized user's financial information, contact lists, and appointments, and just about any other data of interest to the authorized user. Accordingly, one skilled in the art will appreciate that the present invention is not limited to the type of information stored in the memory component 42.

The other useful data is loaded into memory component 42 via interface 46 or wireless interface 49. In the situation where the memory component 42 comprises a one-time- programmable (“OTP”) memory and a re-writable memory, it is advantageous for the OTP memory to store the identity data, and the re-writable memory to store the other useful data. In order to load the other useful data into the memory component 42, the smartcard 40 requires that permission to input the other useful data be granted. Granting of such permission is achieved by validating the authorized user's fingerprint with fingerprint sensor 45, as described at 61 in FIG. 6. If the fingerprint received from fingerprint sensor 45 matches that of an authorized user at 62, the interface 46 and wireless interface 49, if present, are opened for data entry at 64. If data arrives within a predetermined period, such as a few seconds, the smartcard 40 is determined to be in a write mode at 65. Optionally, the smartcard 40 includes a mode selection switch (not shown) to specify that the user intends to write data instead of waiting for the predetermined period. If the smartcard 40 is assigned to multiple authorized users, the CPU 43 recognizes which authorized user the other useful data pertains to based upon header information preceding the incoming data.

The procedure for viewing the other useful data with display component 44 will now be described. An individual attempting to obtain access to the other useful data places his finger on the fingerprint sensor 45 at 61. The CPU 43 then compares this received fingerprint with the authorized users' reference fingerprint data at 62. If the received fingerprint matches an authorized user's fingerprint, the images of that particular authorized user are displayed with the display component 44 at 64. Simultaneously, the interface 46 and wireless interface 49 are opened, also at 64. If data is not received via the interface 46 or wireless interface 49 within the predetermined period described above, the interface 46 and wireless interface 49 close, and the smartcard 40 is determined to be in a read-data mode at 65 and 67. Optionally, the smartcard 40 includes a mode selection switch (not shown) to specify that the user intends to read data instead of writing data to avoid opening of the interface 46 or wireless interface 49.

Once an authorized user has been verified at 62 and the read mode determined at 67, the other useful data is displayed with display component 44 at 68. As previously discussed, the other useful data may include medical information, financial information, or other useful data deemed important to or for the authorized user. If the other useful data contains multiple sets of information, such as multiple EKGs, different financial information, etc., such data is displayed in sequence, allowing a certain period to pass while displaying each set of data. For instance, if an EKG and a sonogram are included in the other useful data, the EKG may be displayed for five seconds and then the sonogram displayed for an equal amount of time. Alternatively, if the smartcard 40 includes a selection button (not shown), such button may be used to cycle through the data.

Turning now to FIG. 5, a smartcard 50 according to the second embodiment of the present invention will be described. The smartcard 50 provides the same functionality as the smartcard 40 described with reference to FIG. 4, and like devices are labeled with the same reference numerals. However, the smartcard 50 includes what is called a “contactless” processor 51. The contactless processor 51 provides the same functionality as the CPU 43, but does not have a physical connection to the other devices on the smartcard 50. The contactless processor 51 communicates wirelessly with the other devices in the smartcard 50 via wireless interface 49. For instance, the contactless processor 51 uses the wireless interface 49 to communicate with the memory component 42 and the sensor 45 via the controller 41. The contactless processor 51 also uses the wireless interface 49 to communicate with external devices via the controller 41.

The advantage of the contactless processor 51 is that fewer physical connections are required in the smartcard 50. This arrangement simplifies the design of the smartcard 50 and allows the visual display component 44 to be larger in the second embodiment than in the first embodiment described with reference to FIG. 4.

It is to be understood that the exemplary embodiments are merely illustrative of the present invention and that many variations of the above-described embodiments can be devised by one skilled in the art without departing from the scope of the invention. For instance, although the exemplary embodiments describe identity data and other data being separately displayed and in a particular order at 64 and 68 in FIG. 6, one skilled in the art can easily modify the disclosed invention to display such data in different orders or together. It is therefore intended that all such variations be included within the scope of the following claims and their equivalents.

1. A smartcard for storing information pertaining to an authorized user, the smartcard comprising:
an energy providing component;
a memory component that stores the information pertaining to the authorized user, the information comprising identity data;
an access control component that receives access data;
a visual display component; and
a processing component connected to the energy providing component, memory component, access control component, and visual display component, the processing component programmed to perform actions comprising:
comparing the received access data to the identity data;
instructing the visual display component to display a warning notification if the access data does not match the identity data; and
instructing the visual display component to display at least a portion of the information pertaining to the authorized user if it has been determined that the access data matches the identity data.

2. The smartcard of claim 1 wherein the information pertaining to the authorized user further comprises second identity data, and wherein instructing the visual display component to display the information pertaining to the authorized user instructs the visual display component to display the second identity data.

3. The smartcard of claim 2 wherein the second identity data comprises an image of the authorized user.

4. The smartcard of claim 2 wherein the second identity data comprises a plurality of images of the authorized user.

5. The smartcard of claim 1 wherein the access control component is a fingerprint sensor, the access data describes a fingerprint applied to the fingerprint sensor, and the identity data describes a fingerprint of the authorized user.

6. The smartcard of claim 1 wherein the information pertaining to the authorized user further comprises other useful data, and wherein the processing component is programmed to perform actions further comprising instructing the visual display component to display the other useful data if it has been determined that the access data matches the identity data.

7. The smartcard of claim 6 wherein the memory component comprises a one-time-programmable (“OTP”) memory and a flash memory, and wherein the identity data is stored in the OTP memory and the other useful data is stored in the flash memory.

8. The smartcard of claim 6 wherein the other useful data comprises medical information about the authorized user.

9. The smartcard of claim 1 further comprising:
an interface communicatively connected to the processing component for transmitting and receiving information.

10. The smartcard of claim 9 wherein the interface facilitates wireless communication between the processing component and external devices.

11. The smartcard of claim 9 wherein the interface facilitates wireless communication between the processing component and at least the memory component, access control component, and visual display component.

12. The smartcard of claim 9 further comprising a second interface communicatively connected to the processing component for transmitting and receiving information,
wherein the interface allows the processing component to communicate wirelessly, and
wherein the second interface allows the processing component to communicate via a physical connection.

13. The smartcard of claim 1 wherein the visual display component comprises a liquid crystal display.

14. The smartcard of claim 1 wherein the energy providing component comprises a rechargeable battery.

15. A smartcard for storing information, the smartcard comprising:
an energy providing component;
a memory component that stores the information, the information comprising identity data for each of a plurality of authorized users;
an access control component that receives access data;
a visual display component; and
a processing component connected to the energy providing component, memory component, access control component, and visual display component, the processing component programmed to perform actions comprising:
comparing the received access data to the identity data for each of the plurality of authorized users;
instructing the visual display component to display a warning notification if the access data does not match any of the identity data for each of the plurality of authorized users; and
instructing the visual display component to display at least a portion of the information if it has been determined that the access data matches the identity data of an authorized user in the plurality of authorized users.

16. The smartcard of claim 15 wherein an authorized user in the plurality of authorized users has different access rights than another authorized user in the plurality of authorized users.

17. A method for testing whether an individual is an authorized user of a smartcard, the method comprising:
receiving access data from the individual via an access control component integral to the smartcard;
comparing, with a processing component integral to the smartcard, the access data to identity data stored in a memory component integral to the smartcard, the identity data pertaining to an identity of the authorized user of the smartcard;
displaying a warning notification with a visual display component integral to the smartcard if the access data does not match the identity data, thereby indicating that the individual is not the authorized user; and
displaying, with the visual display component, other data stored in the memory component if the access data matches the identity data, thereby indicating that the individual is likely the authorized user.

18. The method of claim 17 wherein the other data comprises second identity data used to compare to the individual and determine whether the individual is the authorized user.

19. The method of claim 18 wherein the second identity data comprises an image of the authorized user.

20. The method of claim 17 wherein the other data comprises other useful data.

21. The method of claim 17,
wherein comparing the access data to the identity data compares the access data to a plurality of identity data each pertaining to an identity of one of a plurality of authorized users of the smartcard,
wherein displaying the warning notification displays the warning notification if the access data does not match any of the plurality of identity data, thereby indicating that the individual is not any of the authorized users, and
wherein displaying the other data displays the other data if the access data matches an identity data in the plurality of identity data, thereby indicating that the individual is likely an authorized user.
